(19) United States
(12) Patent Application Publication
(10) Pub. No.: US 2021/0227088 A1
(43) Pub. Date: Jul. 22, 2021

(54) IMAGE FORMING APPARATUS

(71) Applicant: TOSHIBA TEC KABUSHIKI KAISHA, Tokyo (JP)

(72) Inventor: Yasuhiko WATANABE, Chigasaki Kanagawa (JP)

(21) Appl. No.: 17/096,606

(22) Filed: Nov. 12, 2020

(30) Foreign Application Priority Data
Jan. 22, 2020 (JP) 2020-008610

(51) Int. Cl. H04N 1/00

(52) U.S. Cl. CPC H04N 1/00904; H04N 1/00037; H04N 2201/0094; H04N 1/00896; H04N 1/00411; H04N 1/00352

(57) ABSTRACT

An image forming apparatus includes a sensor configured to detect a human in proximity to the image forming apparatus and a user input unit to receive user inputs related to functions of the image forming apparatus. A storage unit is provided for storing a consumable item used in the image forming apparatus. A storage unit detector detects a state of the storage unit. A controller is configured to supply power to the storage unit detector if the image forming apparatus is in a power saving state, the sensor detects a human, and the user input unit does not receive a user input within a threshold time from detection of the human.

### CROSS-REFERENCE TO RELATED APPLICATIONS

This application is based upon and claims the benefit of priority from Japanese Patent Application No. 2020-008610, filed on Jan. 22, 2020, the entire contents of which are incorporated herein by reference.

### FIELD

The present disclosure relates to an image forming apparatus.

### BACKGROUND

A conventional image forming apparatus has a power saving mode, such as sleep-mode. Power saving is realized by shutting off power to certain devices or components in the image forming apparatus. The image forming apparatus also has a function of notifying an administrator or the like of the state of consumable products, such as remaining amount of paper or remaining amount of toner. However, in the power-saving state, since power supply might be shut-off to certain components, the image forming apparatus might not detect that a user has replaced consumables, and there will be a problem in that a discrepancy occurs between the actual state of the consumables and the state of the consumable products for which the administrator was last notified.

### BRIEF DESCRIPTION OF THE DRAWINGS

FIG. 1 is a cross-sectional view illustrating an external configuration of an image forming apparatus according to an embodiment.

FIG. 2 is a diagram illustrating an image forming unit according to an embodiment.

FIG. 3 is a block diagram of an image forming apparatus according to an embodiment.

FIG. 4 is a diagram illustrating an example of a control process when a sheet is replenished in a power-saving state of an image forming apparatus according to an embodiment.

FIG. 5 is a diagram illustrating an example of a control process when the toner cartridge is replaced in a power saving state of an image forming apparatus according to an embodiment.

FIG. 6 is an example of a screen displayed when a yellow toner cartridge is replaced.

FIG. 7 is a diagram illustrating an example of a control process when a waste toner box is replaced in a power-saving state of an image forming apparatus according to an embodiment.

FIG. 8 is an example of a screen that is displayed when a waste toner box is replaced.

### DETAILED DESCRIPTION

According to one embodiment, an image forming apparatus includes a sensor configured to detect a human in proximity to the image forming apparatus, a user input unit configured to receive user inputs related to functions of the image forming apparatus, a storage unit for storing a consumable item; a storage unit detector configured to detect a state of the storage unit, and a controller. The controller is configured to supply power to the storage unit detector if the image forming apparatus is in a power saving state, the sensor detects a human, and the user input unit does not receive a user input within a threshold time from detection of the human.

Hereinafter, certain example embodiments of the present disclosure will be described.

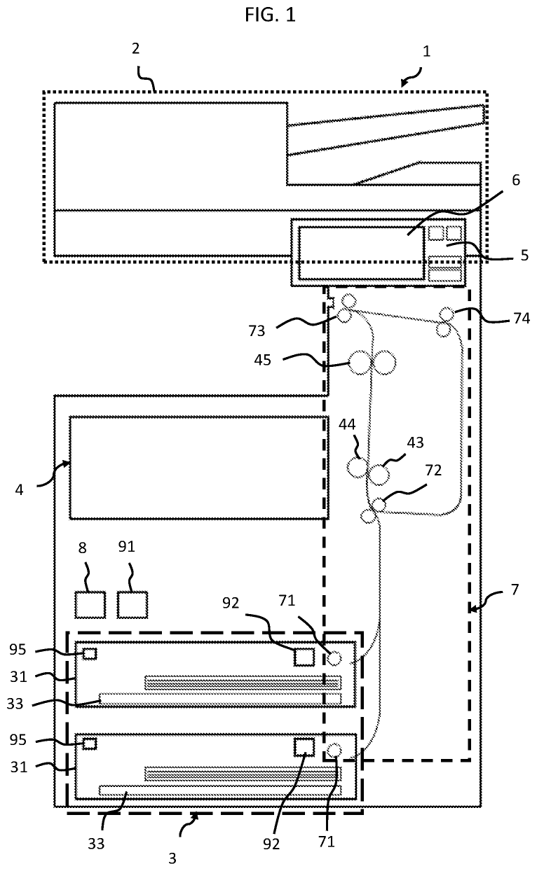

First, a configuration of an image forming apparatus 1 according to the present embodiment will be described with reference to FIGS. 1 to 3. FIG. 1 is a cross-sectional view illustrating a configuration of the image forming apparatus 1.

The image forming apparatus 1 detect the presence of a user who exchanges/replaces consumables, such as sheets (recording media), a toner cartridge 47, or a waste toner box 48, with a human sensor 91 during a power saving state. The image forming apparatus 1 supplies power to a consumables storage unit based on the human sensor 91 detections. In this context, a consumables storage unit is, for example, a sheet feeding cassette 31 that is capable of detecting the presence or absence of a sheet, a toner cartridge 47 that is capable of detecting the remaining amount (level) of the toner (the recording agent) stored therein, or a waste toner box 48 that is capable of detecting the amount (level) of the waste toner. The consumables storage unit is not limited to the specific ones described above, and the consumables storage unit may be any unit provided in the image forming apparatus 1, an external device, or a consumable item itself as long as it has a state detection unit capable of detecting the consumption state of a relevant consumable.

The image forming apparatus 1 according to the present embodiment is configured as, for example, a multifunction peripheral (MFP). As shown in FIG. 1, the image forming apparatus 1 includes a reading unit 2, a sheet feeding unit 3, an image forming unit 4, an operation input unit 5, a display 6, a conveyance unit 7, an interface (I/F) unit 10, and a human sensor 91.

The I/F unit 10 is an interface for connecting an external device to the image processing apparatus. The I/F unit 10 may be a wired interface and/or a wireless interface.

The reading unit 2 acquires image information from a reading target, and stores the read image information in the image forming apparatus 1. The reading unit may be or incorporate, for example, an optical scanner device. The acquired image information may be later printed on to a sheet by the image forming unit 4, or may be transmitted to an external device via the I/F unit 10.

The operation input unit 5 receives an input operation from a user. The display 6 (displays information to the user. The operation input unit 5 and the display 6 may be integrated, for example, as a touch panel display 6, and/or may have physical keys, buttons, switches, or the like.

The conveyance unit 7 includes a pickup roller 71, a registration roller 72, a sheet discharge roller 73, an inversion roller 74, and other conveyance rollers. These conveyance rollers are disposed along the conveyance path of sheets and may serve as relay between the other rollers of the conveyance unit 7. Various conveyance rollers may be provided as pairs or singularly depending on position and design.

The pickup roller 71 picks up one sheet from the top of the sheet stacked in the sheet feeding unit 3. Thereafter, the picked-up sheet is conveyed to the registration roller 72 by a conveyance roller or rollers. The registration roller 72 temporarily delays a conveyed sheet, and then feeds the delayed sheet in accordance with the timing of a secondary transfer roller 43 to which a toner image has been transferred. The sheet fed from the registration roller 72 passes through the secondary transfer roller 43 to a fixing device 45 and is then discharged by the sheet discharge roller 73. When printing is to be performed on both sides of a conveyed sheet, the sheet fed by the sheet discharge roller 73 can be conveyed to an inversion roller 74. The sheet fed from the inversion roller 74 is conveyed back to the registration roller 72, and the sheet then passes again through the secondary transfer roller 43 and the fixing device 45, and a toner image can be transferred to and fixed to the back surface of the sheet, and then discharged by the discharge roller 73.

The sheet feeding unit 3 in this example includes a plurality of sheet feeding cassettes 31. The sheet feeding cassette 31 stores sheets on which an image can be formed, and, generally, the uppermost sheet of the stacked sheets is the one conveyed by a pickup roller 71. The sheet feeding cassette 31 is provided, for example, in a lower portion of the image forming apparatus 1, which may have a door or the like than can be opened and closed so as to permit the sheet feeding cassette 31 to be inserted and removed. When there are the plurality of sheet feeding cassettes 31, then each may store a sheet of a different type or size or the like. The information indicating which type or size of sheet stored in the sheet feeding cassettes 31 may be supplied to, and stored in, the image forming apparatus 1 after the different sheets types have been set in the respective sheet feeding cassettes 31.

A sheet feeding cassette 31 includes a sheet feeding sensor 92 (which is one example of a state detecting device or a state detector) and a lifting plate 33. The sheet feeding sensor 92 detects the remaining amount of the stored sheets. The sheet feeding sensor 92 is, for example, an actuator device. The sheet feeding sensor 92 is provided, for example, in an upper portion of each sheet feeding cassette 31 and detects the presence of a sheet when a force is applied upward on the actuator device. However, in general, the sheet feeding sensor 92 may be any type of sensor that is capable of detecting the presence or absence of media contained in the sheet feeding cassette 31.

The lifting plate 33 is a plate-shaped member which is provided on a floor (bottom) surface of the sheet feeding cassette 31 on which sheets can be stacked. The lifting plate 33 has, for example, an urging member such as a spring or a driven motor and is vertically movable in the up-down direction. When the sheet feeding cassette 31 is opened, that is, when the sheet feeding cassette 10 is pulled out from the image forming apparatus 1, the lifting plate 33 moves to the lowermost part of the range in which the lifting plate 33 can be lifted and lowered. When the lifting plate 33 moves to the lowermost portion, a user can replenish the paper sheet in the sheet feeding cassette 31 to the maximum level.

When the sheet feeding cassette 31 is changed from an open state to a closed state, that is, reinserted into the image forming apparatus 1, the lifting plate 33 moves upward from the lowermost portion by the action of the urging member. When the lifting plate 33 moves upward, the sheets stacked on the lifting plate 33 will come into contact with the sheet feeding sensor 92 and are detected thereby. Generally, in order to avoid hard contact with the sheet feeding sensor 92, a space is provided in the lifting plate 33 at a position facing the sheet feeding sensor 92. Therefore, the sheet feeding sensor 92 does not detect sheets when no sheet is loaded on the lifting plate 33.

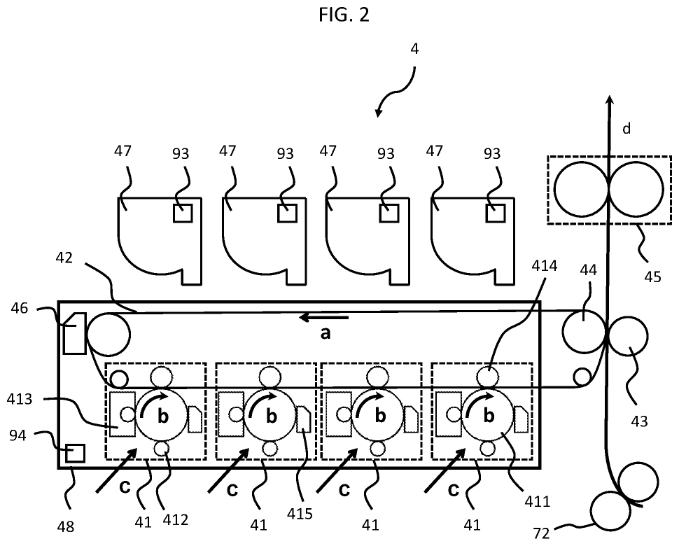

FIG. 2 is a diagram illustrating the image forming unit 4 according to the present embodiment. The image forming unit 4 includes photosensitive members 411, chargers 412, developing units 413, primary transfer rollers 414, a cleaner 415, a transfer belt 42, a secondary transfer roller 43, an opposing roller 44, a fixing unit 45, a transfer belt cleaner 46, toner cartridges 47, and a waste toner box 48.

In FIG. 2 an arrow a indicates a rotation direction of the transfer belt 42, an arrow b indicates a rotation direction of each photosensitive member 411, an arrow c indicates an irradiation direction of a laser from an exposure device, and an arrow d indicates a conveyance direction of a sheet on which an image is formed. Furthermore, since the components included in each of the stations 41 illustrated in FIG. 2 are the same, the individual reference labels for the different components in each of the stations 41 are not repeated in each of the stations, but rather labeled in only a single one of the stations 41.

The image forming unit 4 includes, for example, a yellow station 41 for handling yellow toner, a magenta station 41 for handling magenta toner, a cyan station 41 for handling cyan toner, and a black station 41 for handling black toner. Each of the stations 41 includes a photosensitive member 411, a charger 412, a developing unit 413, a primary transfer roller 414, and a cleaner 415. In FIG. 2, the stations 41 are arranged in order from the left to the right, the yellow, the magenta, the cyan, and the black, respectively, and transfer the toner to the transfer belt 42.

The photosensitive member 411 receives an optical signal (laser light corresponding to arrow c), and an electrostatic latent image is formed thereon corresponding to the optical signal. The charger 412 applies electric charge and electrostatically charges the surface of the photosensitive member 411. The developing unit 413 feeds toner onto the photosensitive member 411 to develop the electrostatic latent image. The primary transfer roller 414 transfers a developed image from the photosensitive member 411 to the transfer belt 42. The transfer belt 42 conveys the developed image to the secondary transfer roller 43. The cleaner 415 removes the toner and any charge remaining on the photosensitive member 411 after the transfer. The secondary transfer roller 43 and the opposing roller 44 are rollers facing each other and a conveyance path of the sheet passes therebetween. The transfer of developer (toner image) on the transfer belt 42 to the sheet from the sheet feeding unit 3 occurs at the secondary transfer roller 43. The fixing device 45 melts the toner on the sheet by applying heat and pressure, and this fixes the toner to the sheet. The transfer belt cleaner 46 removes toner that has not been transferred and so remains on the transfer belt 42.

Each toner cartridge 47 contains toner for forming an image on a sheet and replenishes the developing unit 413 with toner. There can be different types of toner, and for example, in the toner cartridges 47 shown in FIG. 2, yellow, magenta, cyan, and black toners are respectively accommodated in the toner cartridges 47. Each toner cartridge 47 is provided with a first screw and a toner remaining amount sensor 93. The first screw conveys toner to the developing unit. The toner remaining amount sensor 93 detects the amount of toner conveyed by the first screw. The toner remaining amount sensor 93 may be referred to as a state detecting device or a state detector. When the measurement value of the toner amount detected by the toner remaining amount sensor 93 reaches a threshold value, the controller 8 notifies that the toner cartridge 47 should be replaced. The method for detecting the amount of remaining toner is not limited to the above-described method. For example, the cumulative time that the first screw is driven may be measured, and when the measured value reaches the threshold value, a notification indicating that the toner cartridge 47 should be replaced may be issued. Alternatively, the toner concentration in the developing unit 413 may be measured, and when the measured value remains below a threshold value even after a toner replenishing operation, a notification indicating that the toner cartridge 47 should be replaced may be issued. A method of detecting the amount of remaining toner may use an optical sensor, or the weight of a toner cartridge 47.

The waste toner box 48 is installed, for example, on the front side of the image forming apparatus 1 in the image forming unit 4. The waste toner box 48 contains the toner (referred to as waste toner) removed from the photosensitive member 411 and the transfer belt 42 by the cleaner 415 and the transfer belt cleaner 46 of each station 41. A second screw and a waste toner sensor 94 are provided in the waste toner box 48. The second screw conveys the removed waste toner to a predetermined position of the waste toner box 48. The waste toner sensor 94 detects or measures the amount of waste toner conveyed by the second screw. When the waste toner amount detected or measured by the waste toner sensor 94 reaches a threshold value, the controller 8 notifies that the waste toner box 48 should be replaced. The waste toner sensor 94 may be referred to as a state detection device or state detector which identify or provide a current state, level, or amount of accumulated waste toner in the waste toner box 48.

The method for detecting the amount of waste toner is not limited to the above-described method. For example, the cumulative time for which the second screw is driven can be measured and when the measured value reaches the threshold value, a notification may be given indicating that the waste toner box 48 should be replaced. The method of detecting the amount of waste toner may use an optical sensor or the weight of the waste toner box 48.

The notification for prompting replacement of a consumable product such as the paper sheets of the sheet feeding cassette 31, a toner cartridge 47, or the waste toner box 48 may be provided by a notification unit, for example, a notification may be displayed on the display 6, a notification may be made by sound output, or a notification may be sent to an external device via a network or the like. The external device can be, for example, a personal computer (PC) or the like.

The plurality of stations 41 and the plurality of toner cartridges 47 included in the image forming apparatus 1 may be separate pieces or an integrated, single piece. The types of toners that may be used in a station 41 (and supplied from a toner cartridge 47) is not limited to any specific color(s). In some examples, the toner may be a decolorable toner for which an initial printed color disappears upon subsequent heating.

The human sensor 91 detects a person in proximity to the image forming apparatus 1 and outputs a result of the detection to the controller 8. The human sensor 91 may be installed at any position as long as the presence of a person around the image forming apparatus 1 can be detected. In general, the detectable range of persons may be arbitrarily selected. As a detection method of a person by the human sensor 91, for example, a detection using infrared rays, ultrasonic waves, a camera, and/or the like can be used. In addition, a person may be detected by using various other known techniques, and the method(s) used for detecting a person is not particularly limited.

The controller 8 includes a read only memory (ROM), a random access memory (RAM), and a central processing unit (CPU). The ROM stores a control program of the image forming apparatus 1. The RAM temporarily stores the control program. The CPU is hardware for executing the instructions and operations of the control program. The controller 8 controls the respective devices of the image forming apparatus 1 which are connected via a bus 9.

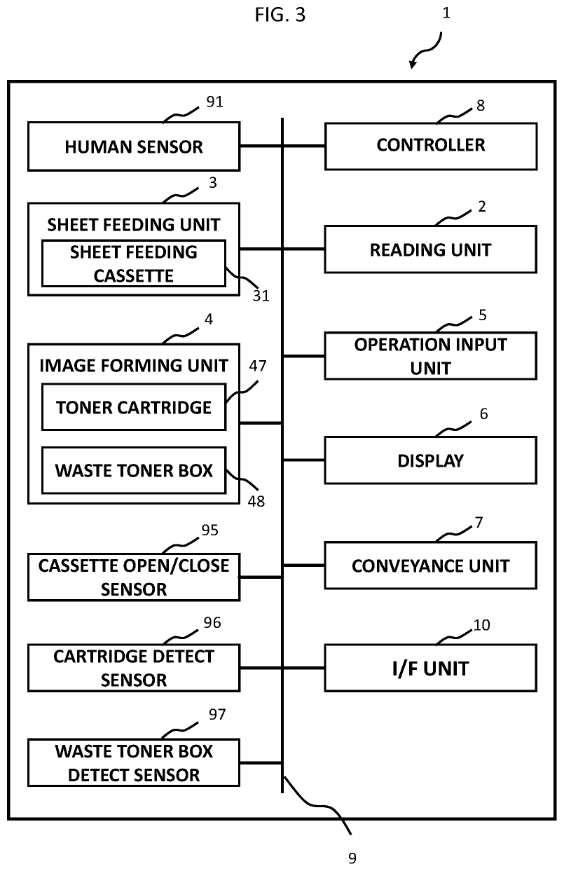

FIG. 3 is a block diagram illustrating a control configuration of the image forming apparatus 1 according to the present embodiment.

The image forming apparatus 1 includes a cassette open/close sensor 95, a cartridge detect sensor 96, and a waste toner box detect sensor 97.

The cassette open/close sensor 95 detects whether or not the sheet feeding cassette 31 is installed in the image forming apparatus 1. In addition, when a plurality of sheet feeding cassettes 31 are provided in the image forming apparatus 1, a cassette open/close sensor 95 can be provided in each of the plurality of sheet feeding cassettes 31, and it can be possible to determine which particular sheet feeding cassette(s) 31 have been installed.

The cartridge detect sensor 96 detects whether or not a toner cartridge 47 is installed in the image forming apparatus 1. In addition, when a plurality of toner cartridges 47 are provided in the image forming apparatus 1, a cartridge detect sensor 96 can be provided for each of the toner cartridges 47, and it can be possible to determine which particular toner cartridge(s) 47 have been installed.

The waste toner box detect sensor 97 detects whether or not the waste toner box 48 is installed. In a case where a plurality of waste toner boxes 48 are provided in the image forming apparatus 1, a waste toner box detect sensor 97 can be provided for each of the waste toner boxes 48, and it can be possible to determine which particular waste toner box(es) 48 have been set.

The reading unit 2, the sheet feeding unit 3, the image forming unit 4, the operation input unit 5, the display 6, the conveyance unit 7, the human sensor 91, the cassette open/close sensor 95, the cartridge detect sensor 96, and the waste toner box detect sensor 97, which are described above, are connected to the controller 8 via the bus 9, and controlled by the controller 8. In addition, the controller 8 can perform various kinds of operations in response to an instruction from the external device connected by the I/F unit 10.

The image forming apparatus 1 includes a counter, a timer, a clock or the like that counts the elapsed time. As the counting method, for example, a real-time clock of the image forming apparatus 1 can be used. The real time clock has a built-in battery, and it is possible to output a signal indicating the current time at any time.

The image forming apparatus 1 includes a mode switching unit or the like. The image forming apparatus 1 can thus switch the power supply between an active state and a power saving state using the mode switching unit. The active state is a state in which power is supplied to all of the respective units of the image forming apparatus 1 to perform various functions. The power saving state is a state in which the power consumption is reduced as compared to the active state. The power saving state may be referred to as a sleep state, a standby state, or the like. In the power saving state, the power supply to various internal components/devices, such as the fixing unit 45, can be interrupted/reduced and these components/devices placed in a state requiring less power than the power consumed in the active state. The switching from the active state to the power-saving state may be performed, for example, by referring to the counter, when a certain period of time has elapsed since a user last operated the image forming apparatus 1 or the user may manually perform an input for switching to the power saving state via the operation input unit 5. In the present embodiment, even in the power saving state, the display 6 and the operation input unit 5 may always be energized, and the human sensor 91 and the portion(s) of the controller 8 related to the control of the power saving state(s) are also constantly energized.

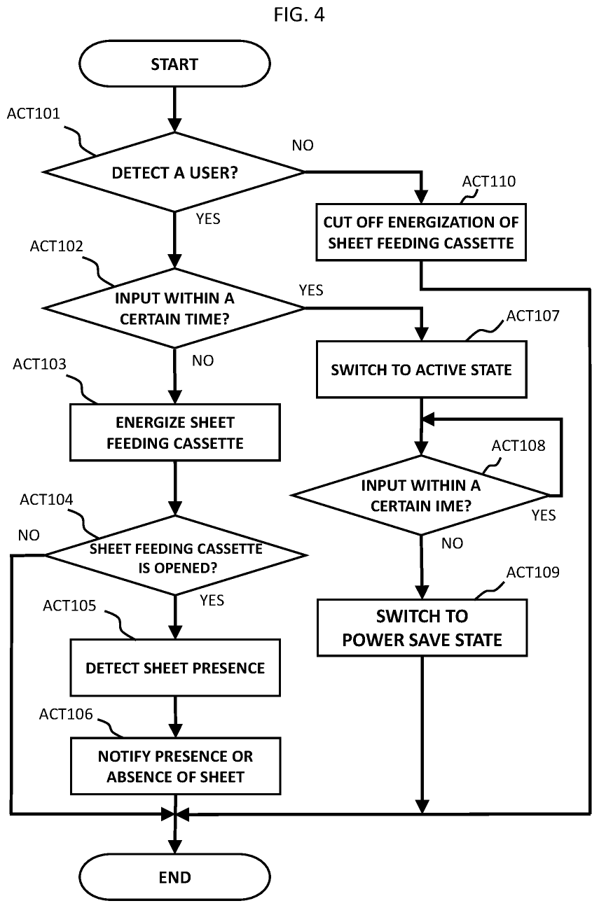

Next, a schematic operation of the human sensor 91 and the controller 8 in the image forming apparatus 1 according to the present embodiment will be described with reference to FIGS. 4 to 8.

FIG. 4 is a diagram illustrating an example of control when a sheet is replenished when the image forming apparatus 1 according to the present embodiment is in a power-saving state. The control when other consumable items are replaced when the image forming apparatus 1 according to the present embodiment is similar.

In ACT101, the human sensor 91 detects a person around the image forming apparatus 1. Here, a person who works on the image forming apparatus 1 will be referred to as a user. When the human sensor 91 detects a person, the elapsed time for the detection may be counted by referring to the counter or the like. By counting the time for which the person is detected, it can be determined whether the person is a user or not 1. Any detected person who does not remain near the image forming apparatus for very long (that is, any person that is only briefly detected by the human sensor 91) is likely just a person who has passed by the image forming apparatus 1, for example. When the human sensor 91 detects the person's presence for some amount of time, the human sensor 91 indicates the detection of a user (ACT101, YES). The time length that serves as a criterion for this determination can be arbitrarily set.

When the human sensor 91 detects a user in ACT101 (ACT101, YES), the presence or absence of an operation on the operation input unit 5 within a certain time is determined by referring to the counter in ACT102. When there is no operation on the operation input unit 5 within a certain period of time (ACT102, NO), the controller 8 energizes the sheet feeding cassette 31 (ACT103). The lack of an input operation by the detected user indicates whether the person detected by the human sensor 91 is a person who will use a function of an image forming apparatus, such as printing or copying, or is a person who will replenish or replace consumables, such as paper, a toner cartridge 47, a waste toner box 48, and the like.

When the sheet feeding cassette 31 has been energized (in ACT103), it can be detected (in ACT104) whether or not the sheet feeding cassette 31 has been opened or closed within some predetermined time by using the counter and the cassette open/close sensor 95. When the cassette open/close sensor 95 detects that the sheet feeding cassette 31 has been set in the image forming apparatus 1 within a predetermined period (ACT104, YES), the sheet feeding sensor 92 detects the presence or absence of the sheet (ACT105).

In ACT106, the controller 8 notifies of the presence or absence of the sheet as detected by the sheet feeding sensor 92 in ACT105. The notification may be indicated by the display 6 or a sound, or may be notified to an external terminal via the network, as described above. When the human sensor 91 detects a user (ACT101, YES), the controller 8 may continuously or repeatedly performs the operations of ACT104.

In ACT101, when a user is not detected by the human sensor 91 (ACT101, NO), the controller 8 waits until the human sensor 91 detects a user. During this time, when no user is detected and if the sheet feeding cassette 31 is energized, the controller 8 cuts off the energization of the sheet feeding cassette 31 (ACT110).

In ACT102, when an operation is performed on the operation input unit 5 within a predetermined time (ACT102, YES), the controller 8 switches the image forming apparatus 1 from the power saving state to the active state (ACT107).

In a case where the image forming apparatus 1 is in the active state, it can be determined whether or not there is an operation input to the image forming apparatus 1 within a certain period of time by referring to the counter in ACT108. If a certain time is counted by the counter in a state where there is no operation from the user (ACT108, NO), the controller 8 switches the image forming apparatus 1 to the power saving state (ACT109). Further, each time an operation is performed on the image forming apparatus 1, counting of the counter is reset, and counting is started again (ACT108, YES). The counted time may be arbitrarily set.

In ACT109, the image forming apparatus 1 is switched from the active state to the power saving state by the controller 8. Thereafter, the controller 8 waits until the human sensor 91 detects a user. The switching of the image forming apparatus 1 to the power saving state may also be caused via an input from the operation input unit 5.

In ACT104, if the opening and closing of the sheet feeding cassette 31 is not performed within a certain period of time (NO in ACT104), the controller 8 returns to ACT101.

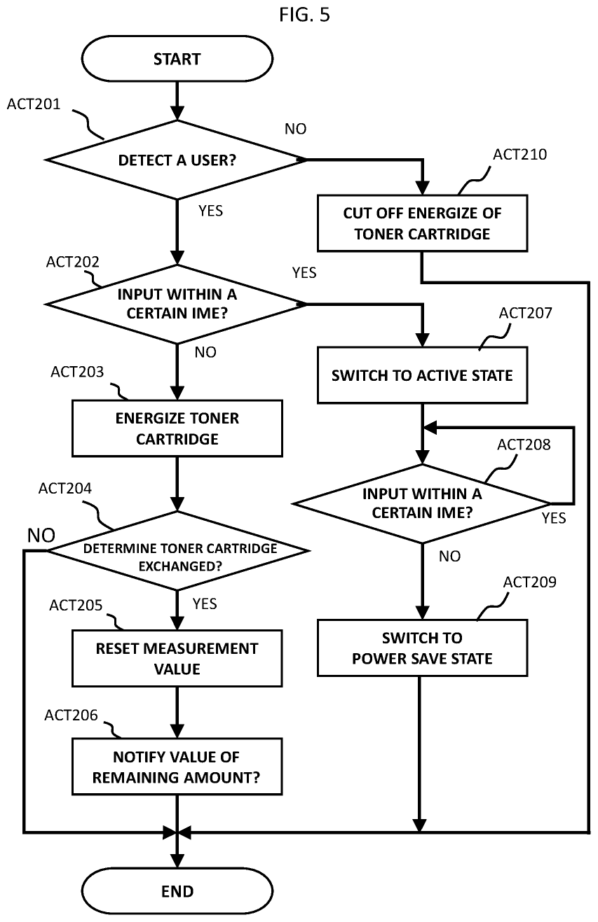

FIG. 5 is a diagram illustrating an example of control when the toner cartridge 47 is replaced as a consumable replacement when the image forming apparatus 1 in the present embodiment is in a power-saving state. The control operations associated with ACT201, ACT202 and ACT207 to ACT209 in FIG. 5 are similar to those of ACT101, ACT102 and ACT107 to ACT109 in FIG. 4.

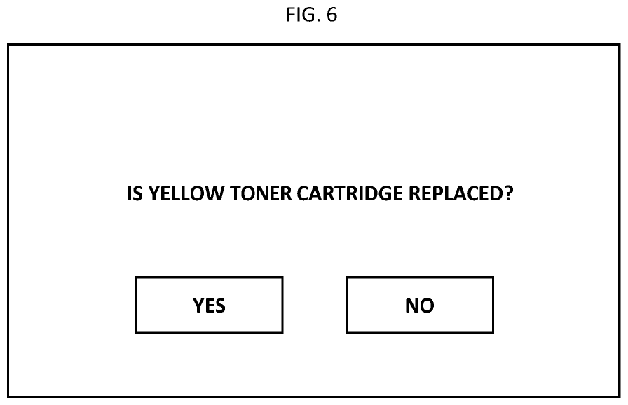

FIG. 6 illustrates an example of a screen that is displayed when a yellow toner cartridge 47 is detached and re-attached. In the display of FIG. 6, when the magenta, cyan, and black toners are detached and re-attached, the appropriate color would be displayed rather than “yellow” as in the example of FIG. 6.

When the human sensor 91 detects the user in ACT201 (ACT201, YES) and the user has not performed an operation on the operation input unit 5 within a certain period of time in ACT202 (ACT202, NO), the controller energizes the toner cartridge 47 (ACT203).

When the toner cartridge 47 has been energized (in ACT203), the it can be determined whether or not a toner cartridge 47 is attached or detached within some predetermined time by using the counter and the cartridge detect sensor 96 in ACT204. If the cartridge detect sensor 96 detects that the toner cartridge 47 has been installed in the image forming apparatus 1 within a certain period of time (ACT204, YES), the controller 8 resets the measurement value of the remaining toner amount of the corresponding toner cartridge 47 (ACT205).

In ACT206, it is notified that the toner cartridge 47 (of the corresponding color) has been replaced and the value of the remaining amount of toner (of the corresponding color) is reset. When the human sensor 91 detects a user (ACT201, YES), the controller 8 may continuously or repeatedly perform the operations of ACT204.

In ACT201, when the user is not detected by the human sensor 91 (ACT201, NO), the controller 8 waits until the human sensor 91 detects the user. If the user is not detected and the toner cartridge 47 is energized, the controller 8 cuts off the energization of the toner cartridge 47 (ACT210).

In ACT204, when the attachment/detachment of the toner cartridge 47 is not performed within a predetermined time (ACT204, NO) and a user is not detected (ACT201, NO), the controller 8 interrupts the energization of the toner cartridge 47 (ACT210). Thereafter, the controller 8 waits until the human sensor 91 detects a user.

In a case where the toner cartridge 47 is attached/detached in ACT204, a screen (see FIG. 6) for selecting whether or not the toner cartridge 47 has been replaced with the new toner cartridge 47 may be displayed on the display 6. When an option indicating that the toner cartridge 47 has been replaced (“Yes” in FIG. 6) is selected, the controller 8 resets the measurement value of the remaining amount of toner in the corresponding toner cartridge 47, and proceeds to ACT206 to notify that the toner cartridge 47 has been replaced. When an option indicating that the toner cartridge 47 has not been replaced (“No” in FIG. 6) is selected, the measurement value of the remaining toner amount is held, and the determination of ACT204 is performed again. As a result, even when the toner cartridge 47 is removed and the toner cartridge 47 is attached again, there is no discrepancy in the measurement value of the remaining toner amount.

In addition, the toner cartridge 47 may be provided with an IC chip that stores IDs of the individual toner cartridges 47. The controller 8 can identify the individual toner cartridges 47 by reading the IDs of the IC chips provided in each cartridge, and can detect whether a toner cartridge 47 has been replaced by comparing the IDs before and after the attachment and detachment of the toner cartridges 47. In this case, if the IDs of the toner cartridges 47 before and after the attachment and detachment are different from each other, the process transitions to the ACT205, and if the IDs of the toner cartridges 47 before and after the attachment and detachment are the same, the determination of the ACT204 is performed again. According to this, it is not necessary to perform control for selecting whether or not the above-described replacement has been performed.

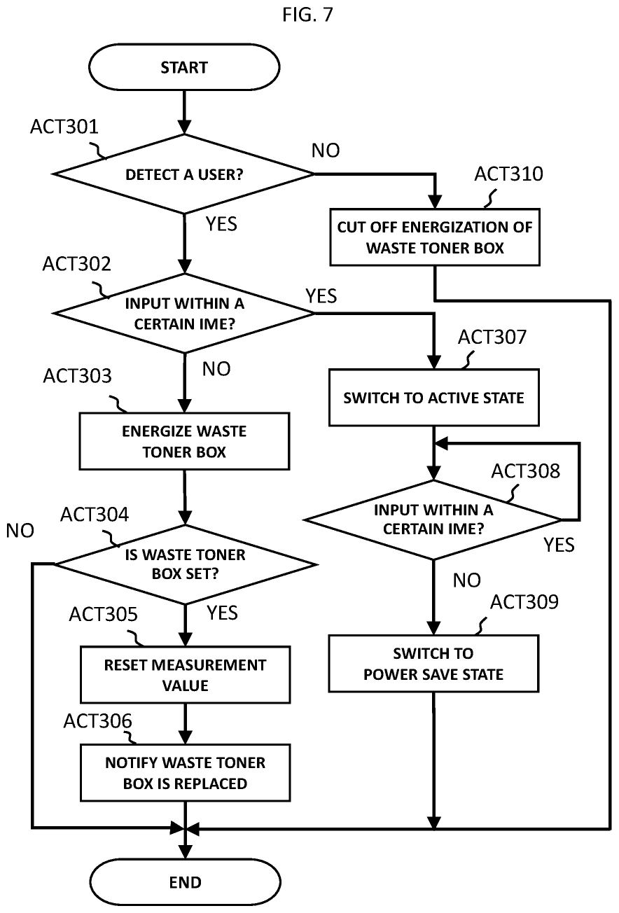

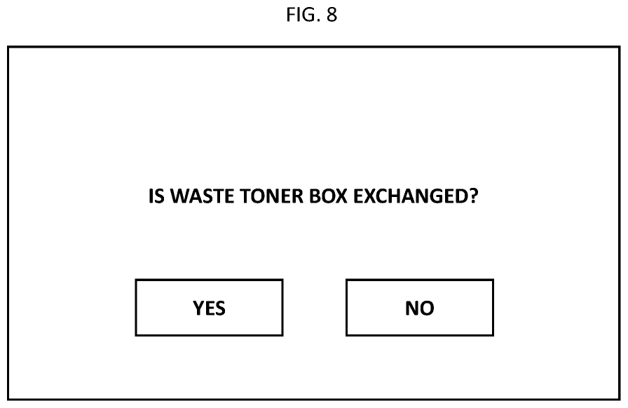

FIG. 7 is a diagram illustrating an example of control when the waste toner box 48 is replaced as a consumable replacement when the image forming apparatus 1 according to the present embodiment is in the power saving state. In FIG. 7, control operations for ACT301, ACT302 and ACT307 to ACT309 are similar to control operations described for ACT101, ACT102 and ACT107 to ACT109 of FIG. 4. FIG. 8 is an example of a screen displayed when a waste toner box 48 is attached or detached.

When the human sensor 91 detects the user in ACT301 (ACT301, YES), and the user does not perform an operation on the operation input unit 5 within a certain period of time in ACT302 (ACT302, NO), the controller energizes the waste toner box 48 (ACT303).

When the waste toner box 48 has been energized (in ACT303), it can be detected whether a waste toner box 48 has been installed in the image forming apparatus 1 within a certain period of time by using counter and the waste toner box detect sensor 97 (ACT304, YES), the controller 8 resets the measurement value of the waste toner amount (ACT305).

In ACT306, it is notified that the waste toner box 48 has been replaced after the controller 8 resets the waste toner amount in the ACT305. When the human sensor 91 detects the user (ACT301, YES), the controller 8 may continuously or repeatedly perform the operations of ACT304.

In ACT301, when the user is not detected by the human sensor 91 (ACT301, NO), the controller 8 waits until the human sensor 91 detects the user. if a user is not detected and the waste toner box 48 is presently energized, the controller 8 cuts off the energization of the waste toner box 48 (ACT310).

In ACT304, when the attachment/detachment of the waste toner box 48 is not performed in a predetermined time (ACT304, NO), and the user is not detected (ACT301, NO), the controller 8 cuts off the energization of the waste toner box 48 (ACT310). Thereafter, the controller 8 waits until the human sensor 91 detects a user.

In a case where a waste toner box 48 is detected as attached/detached in ACT304, a screen for selecting whether or not the waste toner box 48 has been exchanged/replaced with a new waste toner box 48 (see FIG. 8) may be displayed on the display 6. When an option indicating that the waste toner box 48 has been replaced(“Yes” in FIG. 8) is selected, the controller 8 resets the measurement value of the waste toner amount for the waste toner box 48, and proceeds to ACT306 and notify the replacement of the waste toner box 48. If an option indicating that the waste toner box 48 has not been replaced (“No” in FIG. 8) is selected, the measurement value of the waste toner amount is maintained, and the determination of ACT304 is performed again. Accordingly, even when the waste toner box 48 is temporarily removed and then reattached again, the measurement value of the waste toner amount does not vary.

In addition, a waste toner box 48 may be provided with an IC chip that stores an ID for the waste toner box 48. The controller 8 can then identify the individual waste toner boxes 48 by reading the IDs of the IC chips provided in each, and can detect whether or not a waste toner box 48 has been replaced by identifying the IDs before and after the attachment and detachment of a waste toner box 48. In this case, if the IDs of the waste toner boxes 48 before and after the attachment and detachment are different from each other, the process transitions to the ACT305, and if the IDs of the waste toner boxes 48 before and after the attachment and detachment are the same, the determination of the ACT304 is performed again. According to this, it is not necessary to perform control for selecting whether or not the above-described replacement has been performed.

As described above, according to the present embodiment, the image forming apparatus 1 detects the user by the human sensor and energizes the sheet feeding cassette 31, the toner cartridge 47, and/or the waste toner box 48 even if the image forming apparatus 1 is in a power-saving state. As a result, the image forming apparatus 1 can detect the replacement of consumable items, and thus it is possible to notify an administrator service of accurate consumables information, such as the amount of remaining sheets and the remaining amount of toner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed:

1. An image forming apparatus, comprising:
a sensor configured to detect a human in proximity to the image forming apparatus;
a user input unit configured to receive user inputs related to functions of the image forming apparatus;
a storage unit configured to store a consumable item;
a storage unit detector configured to detect a state of the storage unit; and
a controller configured to supply power to the storage unit detector if the image forming apparatus is in a power saving state, the sensor detects a human, and the user input unit does not receive a user input within a threshold time from detection of the human.

2. The image forming apparatus according to claim 1, wherein the user input unit comprises a touchscreen display.

3. The image forming apparatus according to claim 1, wherein the consumable item is paper.

4. The image forming apparatus according to claim 1, wherein the consumable item is toner.

5. The image forming apparatus according to claim 1, wherein the storage unit is paper storage cassette.

6. The image forming apparatus according to claim 1, wherein the storage unit is a toner cartridge.

7. The image forming apparatus according to claim 1, wherein the storage unit is a waste toner box.

8. The image forming apparatus according to claim 1, further comprising:
a consumable item state detector configured to detect an amount of the consumable item in the storage unit.

9. The image forming apparatus according to claim 1, wherein the controller is further configured to update a consumable item amount for the storage unit after the storage unit detector detects the storage unit has been removed from the image forming apparatus.

10. The image forming apparatus according to claim 1, wherein the controller is further configured to reduce power supply to the storage unit detector after a second threshold time elapses without a detection of change in the state of the storage unit by the storage unit detector.

11. A multi-functional peripheral apparatus having a power saving state and a normal state, the apparatus comprising:
a sensor configured to detect a human in proximity to the multi-functional peripheral apparatus;
a user input panel configured to receive user inputs related to functions of the multi-functional peripheral apparatus;
a storage unit for storing a consumable item;
a storage unit detector configured to detect a state of the storage unit; and
a controller configured to supply power to the storage unit detector if the multi-functional peripheral apparatus is in a power saving state, the sensor detects a human, and the user input panel does not receive a user input within a threshold time from detection of the human.

12. The multi-functional peripheral apparatus according to claim 11, wherein the storage unit is a sheet feeding cassette, the consumable item is a paper sheet, and the storage unit detector is a cassette open/close sensor.

13. The multi-functional peripheral apparatus according to claim 11, wherein the storage unit is a toner cartridge, the consumable item is toner, and the storage unit detector is a cartridge detect sensor.

14. The multi-functional peripheral apparatus according to claim 11, wherein the storage unit is a waste toner box, the consumable item is toner, and the storage unit detector is a waste toner box detect sensor.

15. The multi-functional peripheral apparatus according to claim 11, wherein the user input panel comprises a touchscreen display.

16. The multi-functional peripheral apparatus according to claim 11, further comprising:
a consumable item state detector configured to detect an amount of the consumable item in the storage unit.

17. The multi-functional peripheral apparatus according to claim 11, wherein the controller is further configured to update a consumable item amount for the storage unit after the storage unit detector detects the storage unit has been removed from the multi-functional peripheral apparatus.

18. The multi-functional peripheral apparatus according to claim 11, wherein the controller is further configured to reduce power supply to the storage unit detector after a second threshold time elapses without a detection of change in the state of the storage unit by the storage unit detector.

19. An image forming apparatus, comprising:
a human sensor configured to detect a human in proximity to the image forming apparatus;
a user input unit configured to receive user inputs related to functions of the image forming apparatus;
a sheet feeding cassette for storing sheets of paper to be used in the image forming apparatus;
a cassette open/close sensor configured to detect whether the sheet feeding cassette is in an open state or a closed state;
a toner cartridge position at which a toner cartridge can be installed, the toner cartridge for storing toner for use in the image forming apparatus;
a cartridge detect sensor configured to detect the toner cartridge at the toner cartridge position;
a waste toner box for receiving waste toner generated in the image forming apparatus;
a waste toner box detect sensor configured to detect the waste toner box; and
a controller configured to supply power to the cassette open/close sensor, the cartridge detect sensor, and the waste toner box detect sensor if the image forming apparatus is in a power saving state, the human sensor detects a human, and the user input unit does not receive a user input within a threshold time from detection of the human.

20. The image forming apparatus according to claim 19, wherein the controller is further configured to reduce power supply to the cassette open/close sensor, the cartridge detect sensor, and the waste toner box detect sensor after a second threshold time elapses without a detection of change in the state sheet feeding cassette, the toner cartridge, or the waste toner box.
